(19) United States
(12) Patent Application Publication
(10) Pub. No.: US 2014/0278895 A1
(43) Pub. Date: Sep. 18, 2014

(54) SYSTEM AND METHOD FOR INSTRUCTION BASED ACCESS TO ELECTRONIC COMPUTING DEVICES

(71) Applicant: Edulock, Inc., Reno, NV (US)

(72) Inventors: Patrick M. Grimes, Reno, NV (US); Linda S. Grimes, Reno, NV (US); Cody M. Grimes, Reno, NV (US)

(73) Assignee: Edulock, Inc., Reno, NV (US)

(21) Appl. No.: 14/207,261

(22) Filed: Mar. 12, 2014

Related U.S. Application Data
(60) Provisional application No. 61/777,178, filed on Mar. 12, 2013.

(51) Int. Cl. G06F 21/44; G06Q 30/02

(52) U.S. Cl. CPC G06F 21/44; G06Q 30/0231
USPC 705/14.31; 726/28

(57) ABSTRACT

A network-based security system and method for blocking and/or limiting access to a user's electronic computing device (e.g. tablet) until the user answers one or more test questions correctly. The user has the option of selecting the Content (e.g. topic); the Format (e.g. True/False); and the Quantity (e.g. amount of access earned) for each test. The Quantity may be: Open Access with unlimited time constraints, Timed Access with set periods of time to use the device, and Cumulative Access to earn credit points that may be saved for future device access. The entire device may be blocked, or particular functions (e.g. Internet) or software (e.g. games) on the device. The system analyzes the user's test results and trends in test performance and electronically transmits a report to a third party to enable the party to monitor the progress and/or deficiencies of the user.

### RELATED APPLICATIONS

The present application claims priority to and benefit from U.S. Provisional Patent Application No. 61/777,178, titled “System and Method for Instruction Based Access to Electronic Computing Devices” filed on Mar. 12, 2013. The present application is also related to U.S. Provisional Patent Application No. 61/782,006, titled “Method and System for Integrated Reward System for Education” filed Mar. 14, 2013, U.S. Provisional Patent Application No. 61/778,988, titled “System and Method for Multi-Layered Education Based Locking of an Electronic Computing Devices” filed Mar. 13, 2013, and U.S. Provisional Patent Application No. 61/775,623, titled “System and Method for a Comprehensive Integrated Education System (CIES)” filed Mar. 10, 2013. The entire contents of the aforementioned applications are herein expressly incorporated by reference.

### TECHNICAL FIELD

The present invention relates to control of access to an electronic computing device by a third party who requires the user to accomplish specific instructional based objectives in order to use the device.

### BACKGROUND

Psychologists and researchers from around the globe agree that social media, for example, is highly addictive and can be similar to drug addiction. In general, a techno-addict is an individual who is addicted to the use of electronic computing devices (e.g. television, interactive video game, Internet searching, emailing, texting, chatting, twittering, etc.). As they continue staring at the screen, their physical reaction helps their brain focus on the incoming mental stimuli because of the release of the neurotransmitter dopamine that provides them a feeling of euphoria (e.g. the reward for engaging in the activity), while also driving the craving of the activity. It would be helpful to focus on using this window of increased dopamine levels, and hence increased ability to concentrate, to enhance the individual's desire, appetite, and ability to learn new information.

### SUMMARY OF THE INVENTION

Various embodiments of the present invention disclose an educational system, method and computer program product for controlling access to an electronic computing device by a third party administrator, wherein the target user would need to accomplish specific education based objectives, such as correctly answering one or more questions displayed on the device before gaining access to the entire device and/or specific functions/software on the device. The administrator may be a person owning the device (e.g. a third party, such as a parent or supervisor of the user), or the administrator may be a manager of a system server, whom the user and/or their supervisor have granted permission to control the unlocking of the device via a network.

The features discussed in some embodiments may be used in conjunction with other electronic computing devices' locking mechanisms, such as “slide-to-unlock” protected devices and password protected devices. For example, U.S. Pat. No. 7,657,849 entitled “Unlocking a device by performing gestures on an unlock image” discloses a method of unlocking an electronic computing device by touching the device screen in a preset manner, such as sliding an unlock image to a predefined location on the screen and/or moving the unlock image along a predefined path. Or, for devices with Microsoft Operating Systems, features discussed in some embodiments can be linked with the “Parental Controls” feature that allows parents to set limits on the hours that their children can use the computer, the types of games they can play, and the programs they can run. Even when the user overcomes the locking means of these other mechanisms, they are still denied access to their electronic computing devices, or particular features on the device. For example, when the child attempts to access a blocked program or access the device after unlocking the slide mechanism on their tablet, a notification is displayed on the screen that a particular program or the entire electronic computing device has been blocked. The child can click a link in the notification to request permission for access to the program or device, and be re-directed to the testing modules discussed in some embodiments. Only by correctly answering the questions, will the device be unlocked for the child to access the feature (e.g. Internet), program (game), or the entire device's functionality.

The Educational software or modules discussed in some embodiments may also be used in conjunction with existing interactive toys and robots. For standalone toys and robots, and other electronic computing devices that are not connected to a network, the educational software is installed on the device, toy, or robot and coded to be compatible with the specific device and any other computer software associated with it. As a result, the user would have to successfully execute the testing and instructional modules in order to gain access to the device, toy, or robot. And for interactive toys, robots, and other electronic computing devices connected to a network, the Educational software is downloaded to the device, toy, or robot, or accessible via the Question & Answer (Q & A) system server; and is coded to be compatible with the specific device, toy, or robot and any other software associated with it (e.g. toy mobile app).

The user also has the flexibility of selecting how and on what type of subject matter s/he would like to be tested on as categorized by Content, Format, and Quantity. The user may indicate their selection by either typing in, touching a touch screen enabled device, or speaking for an audio enabled device (similarly these options are available for providing responses by end user).

Content comprises the topic or subject matter to be tested (e.g. Math, English, Biology, etc.), and may further comprise subcategories within a selected content. For example, after selecting “Math”, the user would then be given the choice of selecting a subcategory from addition, subtraction, division, multiplication, algebra, geometry, trigonometry, pre-calculus, calculus, etc.

Format comprises standard test formats, such as true/false questions, multiple choice questions, or fill-in-the-blank questions, or other standard question formats used by the academic community, or appropriate for a specific topic (e.g. aligning images on a touch screen enabled electronic computing device for a user training their vision).

Quantity comprises the type of access on the device that the user will be granted if s/he successfully executes the test questions: Open Access; Timed Access; or Cumulative Access. During “Open Access”, the correct answering of one or more questions by the user will give the user unlimited access to the electronic computing device or a particular feature on the device—e.g. time, software, Internet, etc. During “Timed Access” the correct answering of one or more questions by the user, will give the user access to the electronic computing device or a particular feature on the device for a pre-set time period (e.g. one half hour, one hour, four hours, etc.). And during “Cumulative Access” the correct answering of one or more questions by the user, will give the user “usage credit” that may be cashed in at any time in the future to access the electronic computing device, or a particular feature on the device. Certain functions and/or software on the device may require preset amounts of credit in return for access by the user for a set amount of time. The user may build up credit over time, wherein the system server would keep a running tally of the user's credits with each correct answer.

In regards to the “particular feature on the device”, the correct answering of one or more questions by the user, will give the user open, timed, or cumulative access to designated functions and/or software on the electronic computing device. For example, answering one or more questions correctly will permit the user to access the Internet and/or specific websites on the Internet (e.g. the Facebook website), or games loaded into the memory of the device, etc.

The testing modules may further comprise a series of questions, such as those related by subject matter (content—e.g. all calculus), and/or building in complexity, that must be successfully executed by the user before s/he is granted open, timed, or cumulative access to the device, or specific functions/software on the device.

The testing modules may also permit multiple attempts by the user to answer a specific question, such as 3 attempts before the user is locked out of the system for a preset time period before s/he can attempt to test again. The number of attempts permitted and the time delay before the user can attempt to test again can be set by the system administrator (e.g. system server) and/or by the third party (e.g. parent). Additionally, for each wrong answer, the system may permit the user to either attempt to answer the same question again, or answer a similar question related in topic and complexity. Whether the same question or a different question is presented again to the user is determined by the system administrator or by a default system setting based on the type of question. For example, a true/false question would automatically generate a different question, but one that was similar in content and complexity to the previous question.

An additional feature is the step of analyzing trends in the performance of the user after taking one test, and/or on a cumulative basis as the user continues to test over time, in order to assess the progress that the user is making. The analysis may be conducted by modules within the Educational software on the system server, or mobile app, or by third party software designed for metrics analysis of academic testing. The purpose of the analysis is to assist the user in improving their testing performance for academic and professional test situations, and to determine the strengths, weaknesses, and trends for a user's learning capabilities for a variety of content. The learning capabilities status can include an “adaptive learning” element. In such a case, as the student answers questions correctly, the questions (and or question types) get more challenging. Alternatively, as the student answers questions incorrectly, the questions (and or questions types) get less difficult.

And yet another feature is to link the access to the electronic computing device, or a particular feature or software program on the device, to viewing an educational video or live tutor, either before or after the test questions are administered, or both before and after. For example, the user is required to view a tutorial video, then responded to questions covering material presented in the video. If the user answers one or more questions incorrectly, then s/he may watch the video again, or parts of the video specific to the missed question, or a different video that further explains the material under review. And in an alternative embodiment, the user must first respond to test questions, and if one or more of their responses are incorrect, then the user must watch an instructional video specific to the missed question, and then the user retests with the same question, or one of a similar format and topic. Examples of the types of video comprise: training videos such as for CPR, Driver's, Safety, Computer Operation, etc.; any academic material or general knowledge material, etc.

It is also noted that the features discussed in some embodiments are suitable for use in a variety of situations beyond parent/child and teacher/student, such as by employers training employees, clinicians engaging in rehabilitation of patients who are mentally impaired, etc. For example a child with autism could be provided with educational content on basic hygiene routines, while an adult with Alzheimer's could be provided with education content on family history. These features may also be self-monitored learning by an individual who has elected to master a new subject (e.g. foreign language) or exercise their intellect (e.g. memory and analytical exercises for an aging individual). In this scenario, the individual would function as both the system “user” and “third party” by selecting the scope of access denied to the device, such as the entire device or the Internet, or the Facebook website, etc.; and being provided the analyzed results of their progress directly from the system server. The embodiments of this invention are not limited to students and teachers rather they are only examples. Other instances include a variety of “learning environments” such as employers and employees, parents and children, coaches and players, and doctors and patients. Further, the “learning environments” are not limited to traditional academic subjects and may include work safety, chores around the house, team plays, and medical rehabilitation.

The blocking feature discussed in some embodiments may also be overridden at any time in an emergency situation. By inputting in a preset code, the user could gain limited access to the device to place an emergency call (e.g. VoIP to emergency responders or the third party contacts associated with their account on the system server). Likewise, the user could gain access to the device in emergencies to access their email, text, instant message, etc. accounts for transmission of electronic communications to designated contacts.

### BRIEF DESCRIPTION OF THE DRAWINGS

The above and other features, aspects, and advantages of the present invention will become better understood with regard to the following description, appended claims, and accompanying drawings where:

FIG. 1A is an illustration of a user answering a question incorrectly on an electronic computing device to gain access to the device.

FIG. 1B is an illustration of an exemplification of a user correctly answering a question on the electronic computing device and options of the question type.

FIG. 2A is a flowchart of steps of a third party setting up the educational controlled access to an electronic computing device and a user attempting to access the device.

FIG. 2B is a flowchart of steps of a third party setting up the educational controlled access to an electronic computing device and a user earning credit for use in accessing the device.

FIG. 3 is an illustration of the system architecture of a preferred embodiment of a system server storing user and third party records of the Educational software usage.

FIG. 4A is a screen shot of an exemplification of the selection of Content that the user may select from.

FIG. 4B is a screen shot of an exemplification of question Format that the user may select from.

FIG. 4C is a screen shot of an exemplification of types of Quantity of test question answered that the user may select from.

FIG. 5A is a screen shot of an exemplification of a user's choices for timed access to an electronic computing device based upon the complexity of the question.

FIG. 5B is a screen shot of an exemplification of user's choices for timed access to an electronic computing device based upon the increasing complexity of a series of questions.

FIG. 6 is a block diagram describing various methods of remotely locking an electronic computing device.

FIGS. 7A and 7B are to an instant override feature. FIG. 7A describes a general emergency override feature; and FIG. 7B describes 3rd party override feature.

FIG. 8 is a block diagram for an unlocking mobile application for use on a smartphone

FIG. 9 is a diagram illustrating example components of an adaptive learning process.

### DETAILED DESCRIPTION

With the explosion of new computer and mobile applications (i.e. apps) that can disguise and hide the ultimate purpose of a given electronic computing device's software application, a third-party such as a parent, needs help in controlling or monitoring the computer and mobile applications used by their children that facilitate the use of social media. For example, a parent might restrict the SMS (text message) function of a mobile phone by blocking the use of such an application through the network provider during specific periods of time. However, a mobile phone that has had the SMS function blocked by the network provider can still be connected to the Internet providing the child with the ability to download one of several alternative services (or mobile applications) that enable SMS, such as the SMS service on AOL. In other words, the parent could contract with the network provider of the phone service to block the SMS function during school hours. However, if the child has an Internet or cellular connection on their electronic computing device, s/he can still SMS by accessing another feature offered through the Internet or wireless community. Accordingly, a parent (or other 3^{rd} party) can only guarantee compliance with a stated objective at the initial access step of the electronic computing device. In other words, if a parent intends to influence the use of certain features (or apps of an electronic computing device) by their child, then the parent's most defendable control is the initial setup portion of the security access for the electronic device. In this regard, the third-party (e.g. parent) would establish a system where the target end user (e.g. child), gains access to the electronic device in exchange for completion of education-based material.

Manufacturers of electronic computing devices such as laptop and desktop personal computers, smartphones, cell phones, smart televisions, gaming devices, and tablets already provide a security access process system. In some cases options of security control strategies are available, such as slide lock, security number, security letters, combinations, etc. However, all of these strategies are intended to ensure that someone other than the targeted user of the electronic device is denied access.

Various embodiments of the present invention provide a security system designed to block and limit the use of the electronic computing device by the target user (e.g. child), until s/he accomplishes specific education (or instructional) based objectives as controlled by a third party, such as a parent, teacher or employer. As used herein, the term “User” refers to the person (e.g. student) who is attempting to gain access to the electronic computing device and is required to correctly answer one or more questions in order to do so.

As used herein, the term “Third Party” refers to the entity that is being provided information by the system server regarding the user's test performance. For example, a third party may be a parent, an employer, a coach, etc.

As used herein, the term “Administrator” refers to the entity that controls access to the electronic computing device. The administrator may be the third party, or the administrator may be affiliated with the system server who controls the access to the device via a network after being provide permission to do so by the third party and/or the user.

As used herein, the term “Device” refers to an electronic computing device, an interactive toy, and an interactive robot. The term “Electronic Computing Device” refers to any electronic communications device comprising a central processing unit (i.e. processor) (as well as combinations of electronic computing devices) with the ability to transmit and receive electronic communications comprising via Internet and/or cellular connectivity, such as: laptops, desktops, tablets, iPads, iPods, smartphones, cell phones, and personal digital assistant devices, and the like. It also includes smart televisions such as those from Samsung and Apple, as well as gaming devices such as Xbox 360® by Microsoft and PlayStation 3® by Sony.

As used herein, the term “A System” may be used to claim all aspects of the present invention wherein it refers to the entire configuration of hardware and software in all embodiments. In a preferred embodiment, the “system” comprises a user computing device with Internet connectivity (e.g. laptops, tablets, smartphones, etc.). In an alternative embodiment of the present invention, the system comprises a client-server architecture comprising a user computing device with Internet connectivity, such as laptops, tablets, and smartphones, to communicate with a system server via a network, wherein the software is installed on the system server and electronically communicates with the user's device over the Internet. Furthermore, the user's computing device may have modules installed to assist in the user's testing.

As used herein the term “Client” computer or computing device refers to any user, third party, and administrator electronic computing device capable of communicating with a remote server via the Internet such as a tablet (e.g. Kindle®, Nook®, IPad®), smartphone, hand-held “palm top” computer, laptop computer, desktop computer, terminal, PDA (Personal Digital Assistant), PIM (Personal Information Manager), Network computer, wireless communicator (such as a cellular or satellite telephone), a multi-User computing system. The user's client electronic computing device, or client device, may also comprise an interactive robot and/or an interactive toy.

As used herein the term “Server” computer refers to any computing device that stores and runs the Educational software and database storing records of a user's history and profile, and reports provided to the 3^{rd} Parties. The server system also facilitates the collection and distribution of content to and from a multiplicity of client computers and may incorporate academic information generated by a user's school from education software companies like Blackboard and Edline.

As used herein, the term “Software” refers to computer program instructions adapted for execution by a hardware element, such as a processor, wherein the instruction comprise commands that when executed cause the processor to perform a corresponding set of commands. The software may be written or coded using a programming language, and stored using any type of non-transitory computer-readable media or machine-readable media well known in the art. Examples of software discussed in some embodiments comprise any software components, programs, applications, computer programs, application programs, system programs, machine programs, and operating system software.

As used herein, the term “Module” refers to a portion of a computer program, software or computer hardware that carries out a specific function (e.g. testing module, etc.) and may be used alone or combined with others.

FIG. 1A and FIG. 1B are exemplifications of screen shots that a user would see on their electronic computing device after completing one or more test questions in an effort to gain access to the device or functions/programs on the device (e.g. video game, Internet, etc.). FIG. 1A is an exemplification of the message a user might see if s/he were denied access for failure to answer the question correctly. FIG. 1B is an exemplification of the message a user might see if s/he successfully answered one or more consecutive questions and were granted access to the device.

### Flowchart of Educational Software Steps

The Educational software comprises the following general flowchart of logic steps as illustrated in FIG. 2A for the user wanting immediate access to the device. FIG. 2B is an alternative embodiment, wherein the user is able to immediately utilize earned credit or save it for future use of the device. In both FIGS. 2A and 2B, the electronic device may comprise: an electronic computing device (e.g. tablet, laptop, smartphone, etc.), an interactive toy, or a robot.

As illustrated in FIG. 2A, step 210, the third party or system server administrator creates an account for the user and the third party on the system server, and sets up the electronic computing device, interactive toy or robot, to have access to it controlled by the Educational software executed by a central processing unit (either on the device or the Q & A system server 340). The Q & A server can be the electronic device or one remotely available (or a combination in the event of disrupted connectivity). In step 220, the Educational software on the Q & A system server as executed by the central processing unit or the user's device—generates a question for the user to answer in order to gain access to the device. The question may be selected by the system randomly, or sequentially as part of a graduated learning program (e.g. see FIG. 5B). Graduated learning is another example of “adaptive learning”. In step 230, the user enters their answer to the question via keystroke input, touch contact on the device screen, or audio input as appropriate to the device's functionality. In step 240, the central processing unit (CPU) executing the Educational software on the Q& A server or on the device determines if the answer is correct. If it is not, the user is denied access and a message appears informing them of such (see FIG. 1A for an example message). At this point (step 250), the system may be setup to permit the user to retry, such as to retry up to 3 times, to answer the question. The next attempt by the user may be for the same question, or a similar question in content and complexity, as determined by the CPU. If after the set number of allowed attempts the user is still not able to correctly answer the question (or questions if s/he selected groups of questions-see FIG. 5B), then s/he is denied access to the device for a set period of time (e.g. minutes, hours, days, etc.) and a report of the failed attempts is sent by the CPU to the 3^{rd} Parties electronic communications account (e.g. SMS text message, email, instant message, etc.) (step 260). The permitted time between attempts may be set by the CPU, administrator, or third party.

If on the other hand, the CPU determines that the user's answer(s) is/are correct in step 240, then s/he is granted access to the device or function/program on the device as shown in step 270. The level of access comprises the amount of time the user has earned on the device, and whether to the entire device or specific functions and programs on the device. It is based upon: 1) the user's selection of a time period (see FIGS. 5A and 5B) prior to testing; and/or 2) as pre-determined by the system CPU (i.e. preprogrammed in Educational software), administrator, or third party. And the Quantity, or period of time, may be either “Open Access” comprising no time limitation once the user has gained access to the device; or “Timed Access” for a specified period comprising minutes, hours, or days.

After the user completes testing for a session, whether s/he has gained access to the device or not, the CPU will analyze the user's performance to identify trends, strengths, weaknesses, etc. in the user's testing abilities. (See the “Analysis of Test Results” section infra). (step 280). Additionally, or alternatively, the CPU analysis may be conducted on a periodic basis as set by the Educational software, administrator, or third party. For example, the analysis may be executed every week, bi-weekly, monthly, etc. It may also be altered as needed. For example, for the few months preceding a standardized test, such as the SAT, ACT, GMAT, etc., the analysis may be set to occur daily while the test questions are geared to be similar to those on the test. This constant analysis provides ready feedback to the user to assist them in identifying their areas of weakness on the upcoming test, and motivation to work to improve those areas. For instance, an “adaptive learning” element can be applied where as the student answers standardized questions correctly, the questions (and or question types) get more challenging. Alternatively, as the student answers questions incorrectly, the questions (and or questions types) get less difficult. The “adaptive learning” can incorporate additional features such as those described elsewhere in this document pertaining to facial recognition and optical scan analyses. In these instances the electronic computing device used by the end user serves an additional purpose by measuring bio-physical aspects of the end user to enhance their learning experience. In other words, some end users may form disgruntled looks on their faces or roll their eyes when they are frustrated with the learning objective. It is an intent of this invention, among other things, to intercept the learning experience before the end user answers a question incorrectly by changing the value of reward (and thereby increasing motivation) or by decreasing level of difficulty. The same bio-physical observations can be made with reward selection and assignment and therefore the same interception strategy can be followed. Bio-physical observations include sound level detection, heart-rate, blood pressure, sleeping pattern, etc. Educational institutions, specialized learning agencies, and/or supervisors may work together towards the compilation of necessary materials based on first-hand teaching experiences or additional research.

Lastly, in step 290 the CPU will generate a progress report on the user's performance, and transmit the report electronically via a network to the third party, and/or administrator (e.g. employer). The report is stored in the third party's, administrator's, and user's record in the system server database. The report may be electronically sent every time the user has participated in a test session, or on a periodic basis, as per the CPU analysis of the user's performance. The report may comprise a variety of types of information on the user and statistical analysis or other computations executed by the CPU comprising: number of attempts to gain access to a device within a set time period; success or failure at attempts; trends in performance—strengths, weaknesses, etc., and/or the actual questions and answers on the test, percent improvement from previous test or over a period of time, and so forth (see “Analysis of Test Results” section infra). The content of the report may be determined by the Educational software, administrator, or third party.

In an alternative embodiment of the invention as illustrated in FIG. 2B, the user may be testing for a Quantity of “Cumulative Access” comprising credit points to access the device at that time, or in the future. The steps are synonymous to the embodiment supra as per FIG. 2A, with the addition of steps 265 and 275. After the system CPU determines the user's answer is correct (step 240), the CPU calculates how much credit the user has earned for that particular question and add it to the user's account balance stored within their account on the system server (step 265). Then the CPU must determine if the user has earned enough credit to access the system for a set period of time (e.g. 5, 15, 60 minutes). If so, the user may then immediately access the device; or s/he may save the credit for future use (step 275). Steps 280 and 290 are the same as per the immediate access scenario in FIG. 2A, with the exception that the 3^{rd} Party is provided the user's credit balance in the progress report electronically sent from the system server 340 to the 3^{rd} Parties device 320.

### Video Tutorials

In another embodiment of FIGS. 2A and 2B, a video may be shown to the user prior to being sent any test questions (step 220). The video is a short tutorial to convey information about a particular Content that the user has selected, such as a tutorial from Khan Academy available through YouTube. For example, the user has selected a Content of “Biology—Choice C” (see FIG. 4A), and the tutorial is on DNA replication, which is on an upcoming MCAT the user is scheduled to take. At the completion of the video, the user will be asked one or more questions (step 230) relating to steps in DNA replication that were displayed in the video. If the system server determines that the user did not answer one or more questions correctly (step 240), the user is denied access to the device (step 250) and s/he may opt to view the tutorial again, or another video explaining the specific question that s/he answered incorrectly. The user may then retest the same questions or a different but similar question pertaining to the same content that s/he answered incorrectly. In alternative embodiment, the user may be shown the video only after s/he has answered the question(s) incorrectly. Further still, anti-cheating provisions can be included which ensure that the student is watching the video for the prescribed time by using optical scanning technology. In these instances, one or a combination of electronic computing devices are used in coordination with the learning objective to ensure that the targeted learning is engaged as the learning material is presented to him. For further still, analytics can be performed that track the students average reading speed to their reading speed during engagement in particular learning modules to decipher if the student is reading to fast to comprehend new information for example.

### Analysis of Test Results

The Educational software, and/or any other entity derived testing and education software (e.g. SAT practice test questions software), that are stored on the system server will analyze the user's testing performance after the user has completed the testing modules for one period, and/or on a continuing basis as the user repeatedly tests. A multitude of types of analyses can be performed on the user's test data, such as the following, and any combinations thereof:
The user's time to provide answer to question. This information can help identify trends such as high aptitude areas as well as weaknesses in certain question taking strategies (such as not reading all the answers provided to look for the best answer choice).
Trends to the time of day can help identify periods of the day where a user performs at higher and lower intellectual intensity.
Results from different core subjects compared together can be a useful tool in identifying learning trends based on interest. For example, a user performs well in math, art and science but not geography could suggest the person is not engaged.
Results for cognitive versus pattern recognition can surface brain development differences leading to new education strategies.
Results of how a user learns new information in terms of audio, visual and reading can lead to invaluable tools for enhanced learning.
Results of native knowledge, such as general understanding of physics and geography, compared with school knowledge such as chemistry, are compared to the background information provided to the person taking the question so as to provide a more accurate evaluation of the performance of the user.
Results of question types, such as multiple choice, true/false and fill-in-the-blank, can reveal test taking strategies rather than academic subject weaknesses.
Trends of the day, week or month for optimal user testing performance can be helpful in assisting a user in scheduling their academic workload and standardized testing.
Trends related to age can demonstrate correlations with maturity.
Trends related to social activities may require isolation to confirm suspicions about trends of distractions. In particular, understanding the SMS activity or social networking activity before, during and after an education session could reveal disturbing trends of social distractions.
Trends related to school test dates can be conducted with a simple interface with a student's calendar. Revealing anxiety the day before a scheduled test can create opportunity for subtle time management changes.
Trends of a user compared to those of his class, school, school district, state, etc. in a particular field of study can be of great value. For example, if the questions within the Q&A system database were generated by a school district a user could know at any particular time his competence compared to his peers.
Trends compared to results for similar subjects in a classroom could help reveal teaching/learning conflicts. For example, if the analyses showed that a user performs well on all math test questions, but not well on similar subjects in school one can investigate the cause for the difference.
Trends compared to results obtained from aptitude tests such as SAT, MCAT, GMAT.
Trends compared to results from different location as generated by GPS.

The assessment is a particularly relevant place to, among other considerations, utilize additional analytical aspects such as bio-physical such as optical scanning. For example, a simple cross-check can be conducted to compare the end users average reading speed (as determined by number of words read by number of seconds) and compare that speed to the speed to sections where a learning problem surfaces. Further to the invention, the analysis can include an analyses of the eye engagement as determined by the optical scanning features of various smart devices involved in the learning process.

### System Architecture

As illustrated in FIG. 3, the general system architecture discussed in some embodiments comprises the following: 1) the one or more User's Client System 310 electronic computing device (e.g. student's tablet); 2) a second type of User's Client System 315 comprising an interactive toy or robot with Educational modules/software installed within its operating memory; 3) one or more Third Party's Client System 320 (e.g. parent's smartphone, cell phone, laptop,); 3) the Network (e.g. Internet) 330; 4) the Q&A System Server 340.

The “Network” comprises any public network such as the Internet or World Wide Web, or any public or private network as may be developed in the future, which provides a similar service as the present Internet. A Client System is a User's electronic communications device 310 with web browser capabilities (e.g., tablet, laptop, smartphone, etc. . . . ), and/or a user's interactive toy or robot 315, both of which are configured to communicate with the System Server 340 via the Network 330 in order to receive and respond to testing modules. The User's Client System is further enabled to input user's selections within the Q&A software by a user typing from a keyboard, physically contacting a screen of a touchscreen device, or speaking in an audio enabled device. Alternatively the modules may be loaded into the computing memory of device 310 and 315. Likewise, the Third Party's System 320 is an electronic computing device with web browser capabilities or cellular capabilities (e.g., laptop, smartphone, cellphone, etc. . . . ) configured to communicate with the Q & A System Server 340, via the Network 330. The User's and Third Party's System may connect to the network via a variety of methods such as a phone modem, wireless (cellular, satellite, microwave, infrared, radio, etc.) network, Local Area Network (LAN), Wide Area Network (WAN), or any such means as necessary to communicate to a server computer connected directly or indirectly to the Network. The services that would be included would include all communications such as radio communications and satellite communications along with 2G to 4G Wi-Fi, cable and combinations as well.

In alternative embodiments of the invention, the User's System 310 and the Third Party's System 320 are one in the same electronic computing device with the Educational modules installed thereon. The Educational modules enable the third party to select and/or review the activity of the user in practicing the Educational testing modules, or to self-administer the tests. In one preferred embodiment, the third party's access to the Educational modules is protected by a security feature (e.g. login credentials) to permit them to select which testing modules are available for the user to select from.

The Q & A System Server 340 comprises: a network card or other device for connecting to the Network 330; a memory unit comprising random access memory (RAM) for program execution, flash memory, and hard disc drive and storing the Educational software; a central processing unit (CPU) executing the testing software; and a system database storing records of the user's and third party's account activity. Users' records may comprise, for example: the user's date, time, GPS location, and number of attempts to access the device; as well as reports on test results comprising trends and other analysis. Third parties' records may comprise a history of the electronic communications sent to the third party to report on the user associated with a third party's account.

### Computer Program Product

Additional features discussed in some embodiments may further comprise a computer program product downloaded or pre-installed on the device, such as a mobile app on the user's and 3^{rd} party's electronic computing device (e.g. smartphone, tablet, etc.) The Educational software and the computer program product may comprise a cloud version and/or a hybrid version that uses cloud computing and conventional servers.

The computer program product (“App”) may comprise a native application, a web application, or a widget type application to carry out the methods of graphically displaying the age (i.e. the duration since the last viewing) of content on a computing device screen. In a preferred embodiment, a native application is installed on the device, wherein it is either pre-installed on the device or it is downloaded from the Internet. It may be written in a language to run on a variety of different types of devices; or it may be written in a device-specific computer programming language for a specific type of device. In another embodiment, a web application resides on the system server and is accessed via the network. It performs basically all the same tasks as a native application, usually by downloading part of the application to the device for local processing each time it is used. The web application software is written as Web pages in HTML and CSS or other language serving the same purpose, with the interactive parts in Javascript or other language serving the same purpose. Or the application can comprise a widget as a packaged/downloadable/installable web application; making it more like a traditional application than a web application; but like a web application uses HTML/CSS/JavaScript and access to the Internet.

The User's client system 310 and 315 comprises Educational mobile app modules to enable the user to practice the test questions. Successful completion of the module permits the Q & A System Server 340 to unblock: the entire device 310, 315, and/or particular features of them (e.g. Internet access or texting capabilities).

Furthermore, the system architecture for the exemplified user's electronic computing device with Internet capacity (e.g. a smartphone, tablet, etc.) comprises: an internal telephone microphone/speaker (e.g. when the device is a smartphone, cell phone); a central processing unit (CPU); a graphical processing unit (GPU); a User interface with touchscreen data input keypad or keyboard or keys; memory such as random access memory (RAM), read only memory (ROM), nonvolatile memory such as EPROM or EEROM, flash memory or hard drive memory; a transceiver functionally connected to an antenna to receive and transmit data in a wireless network; and Educational Mobile App Modules stored on an additional internal memory chip. The transceiver may operate according to standards commonly known in the art by the skilled practitioner, such as for GSM, GPRS, wireless local and personal area network standards, and Bluetooth®.

GPU comprises a graphics rendering module configured to perform various tasks related to calculating and displaying the screen images, as well as the Educational videos. Screen manager with a software or firmware process that manages content displayed on the GUI. The screen manager monitors and controls the physical location and type and appearance of content data displayed on the GUI.

The electronic computing devices further comprise hardware/software for Internet connectivity to receive emails, SMS texts, chat messages, and engage in VoIP conversations. The devices comprise Enhanced Data Rate for Global Evolution (EDGE), 3G, and/or 4G data transfer capabilities. The electronic computing device further comprises global positioning system capabilities.

### Alternative System Architectures

Interactive Toys and Robots:

Additional features discussed in some embodiments comprise a standalone client electronic computing system that is not connected to a network. The Educational software is installed on the device by the original equipment manufacturer (OEM); or installed locally (e.g. compact disc). For example, testing modules and functionality may be added to existing interactive toys and robots, such as: an interactive doll (e.g. Little Mommy™ by Mattel).

The features discussed in some embodiments may also be incorporated to work with existing software and mobile apps for an interactive toy or robot, such as Furby by Hasbro critter with a mobile app; and the Disney Pixar cars 2 AppMates. The Educational modules are coded to work with the toy or robot software (e.g. mobile app) and downloaded onto the interactive toy or robot, or pre-installed by the OEM of the toy/robot. The user is then blocked from playing with the toy or robot until s/he has successfully answered the testing modules as per FIG. 2A or FIG. 2B.

Incorporation with Existing Software

The features discussed in some embodiments may also be incorporated to work with existing testing software and mobile apps by downloading onto the device if coded to work with specific other testing apps, or if coded by the OEM as one app. For example, the ability to control access to a learning tablet (e.g. LeapPad2 by Leap Frog) can be modified by installing onto the tablet Educational modules that are coded to be compatible with LeapPad apps or that are encoded into the LeapPad apps by the software or OEM manufacturer.

The features discussed in some embodiments may also be incorporated with other commercially available test taking software that is targeted for a specific purpose, such as to improve a student's SAT score. The modules that control access to the device are incorporated into or designed to work with the SAT (or the like) testing software to provide SAT (or the like) specific questions and grading of the user's performance by topic or skillset in a manner that improves the user's performance for the real standardized test.

### Exemplifications

As illustrated in FIGS. 5A and 5B, the following exemplification is for a user who has selected “Math” as the Content (e.g. choice “A” in FIG. 4A). The Educational testing modules may then display subcategories of content from which the user may select. For example, when the user selects to test their math skills, s/he is re-directed to a screen that permits them to select from addition, subtraction, division, or multiplication. The user may then select the testing format of “fill-in-the-blank” (e.g. choice “B” in FIG. 4B); and the testing quantity “Timed Access” (e.g. choice “C” in FIG. 4C). This generates a screen from which the user selects the amount of time to access the electronic computing device based upon the complexity of the question (see FIG. 5A). For example, a basic math question in addition would earn them “5” minutes of access (e.g. choice “A” in FIG. 5A), while a complex question in addition would earn them “60” minutes of access (e.g. choice “D” in FIG. 5A).

In an alternative embodiment, as illustrated in FIG. 5B, the user may earn minutes of access (or credit if s/he selected choice “C” for a Quantity of Cumulative Access in FIG. 4C), based on the number of consecutive questions of increasing complexity that s/he correctly answer. For example, two correct answers of increasing complexity in the same Content area would earn a user 5 minutes of access (see FIG. 5B, choice “A”); while five consecutive correct answers for questions of increasing complexity in the same Content area would earn a user 60 minutes of access to the device (see FIG. 5B, choice “B”). The user may user the credit at the time of testing to access the device, or at a later time of their choosing.

### Locking Software Component

FIG. 6 is an illustration of the Locking Software combinations that can serve to effectively disable features of a devices (such as smart phone, lap top, smart tv, smart cars, etc.) until the user completes one or more desired tasks that will allow the user to earn back time or features. In particular, the following are an overview of each of the individual numbered features.
Whereas the device has a user interface (600) comprised of a display to view operating system (603) output and application (612) output as well as one or more methods to detect user input, including but not limited to hardware control buttons (602) such as a keyboard or function key, a touchscreen (601), a mouse pointer device (614), a camera or optical sensor (615), and/or a game controller device (613).
Whereas the device has a software or firmware based operating system (603) that allows applications created by third parties to accept input from the user interface and to control output to the display (601).
Whereas the operating system (603) exposes one or more application programming interface(s) to allow third party applications (612) to monitor and/or intercept device user interface (600) input, and to control the device hardware through software commands.
Whereas the operating system (603) exposes one or more application programming interface(s) to allow third party applications (612) to selectively kill running processes or applications (612).
Whereas the operating system (603) has a method of utilizing network connectivity hardware (607) such as a network interface driver (606) to allow the device to connect to a plurality of computer devices on a network, such as the Internet (608).
Whereas the device operating system (603) or third party application (612) provides a software firewall (605) that is capable of controlling access to the network by selectively allowing or denying access to the network.
Whereas applications (612) often require access to the internet (608) and more specifically to internet resources (611) such as a control server (610) that may include application functionality support and a database containing data essential to the functionality of the application (612).
Whereas the operating system (603) requires connectivity to a remote DNS (Doman Name Service) Server (609) in order to support application (612) access to control servers (610) and internet resources (611).
Whereas the operating system (603) maintains network connectivity settings, including an internet protocol address for the device's network hardware (607) as well as remote service addresses including the IP address of one or more DNS (Domain Name Service) servers, as required to provide name resolution for accessing a control server (610) and other internet resources (611) such as a website or web service.
Whereas the operating system (603) supports applications (612) such as Locking Software (604) starting each time the operating system (603) is initialized.

Using FIG. 6 and the definitional references provided as a background, the Locking software (604) could provide one or more layered lock methods to ensure that users utilize the device in a particular way. Those lock methods include but are not limited to:
1. Instruct the Locking Software (604) to present display (601) output that occupies the entire display, and intercepts all user interface (600) inputs to selectively disregard any input that would cause the Locking Software (604) to stop or close.
2. Instruct the Locking Software (604) to modify the Software Firewall (605) rules such that access to the Internet (608) is selectively disabled.
3. Instruct the Locking Software (604) to command the operating system (603) to use a software proxy (617) to inject Locking Software content in the response data from internet resources (611).
4. Instruct the Locking Software (604) to command the operating system (603) to disable the network hardware (607) so that connection to the network or internet is disabled. (Airplane Mode)
5. Instruct the Locking Software (604) to command the operating system (603) to use a DNS server (609) that is interfaced or associated with the Locking Software control server, effectively redirecting all remote internet resource (611) requests back to the control server (610) for selective processing.
6. Instruct the Locking Software (604) to command the operating system (603) to use a proxy server (616) that is interfaced or associated with the Locking Software control server, effectively filtering all remote internet resource (611) responses for content replacement or injection.
7. Instruct the Locking Software (604) to command the operating system (603) to kill any running process that is not explicitly allowed by the Locking Software or required by the operating system.
8. Instruct the Locking Software (604) to command the operating system to disable network hardware (607).

Once the device has been locked (preventing the user from using the device freely), the user can be required to perform specific tasks in order to regain access to third party applications (612), operating system features (603), and internet resources (611).

### Emergency & Instant Override Features

The blocking feature discussed in some embodiments may also be overridden at any time by the user in an emergency situation. By inputting in a preset code into the device, the user can gain limited access to the device to place an emergency call (e.g. VoIP to emergency responders or to the third party associated with their account on the system server); or to gain access to email, text, instant messaging, or the like functionality on the device for transmission of electronic communications to designated contacts. The user's record stored on the database of the Q & A system server 340 will comprise a list of designated emergency contacts and their electronic communications addresses (e.g. mobile numbers for calls or texts, email addresses, etc.). The code for overriding the device block may be a personal code designated by the user and stored in their account on the Q & A system server, or it may be a universal code for all users of the system. The code may also be input into the device via keystroke, touch input to a touch screen, or audio input. Additionally, every instance of the user's implementation of the emergency override is recorded in their system record and electronically conveyed instantly to the third party affiliated with the user's record.

The blocking feature may also be overridden at any time by the user in an emergency situation. By inputting in a preset code into the device, the user can gain limited access to the device to place an emergency call (e.g. VoIP to emergency responders or to the third party associated with their account on the system server); or to gain access to email, text, instant messaging, or the like functionality on the device for transmission of electronic communications to designated contacts. The user's record stored on the database of the Multi-Layered Education Lock server will comprise a list of designated emergency contacts and their electronic communications addresses (e.g. mobile numbers for calls or texts, email addresses, etc.). The code for overriding the device block may be a personal code designated by the user and stored in their account on the system server, or it may be a universal code for all users of the system. The code may also be input into the device via keystroke, touch input to a touch screen, or audio input. Additionally, every instance of the user's implementation of the emergency override is recorded in their system record and electronically conveyed instantly to the third party affiliated with the user's record.

FIGS. 7A and 7B illustrate an instant override feature discussed in some embodiments. In each case, the override provides for by-pass to the learning modules so that the device can be used for emergency contacts or the device can be used by the third-party or parent in such a manner that he is not forced to answer the education content.

FIG. 7A describes a general emergency override feature (4) but those well-known in the art will understand multiple alternatives are available. The emergency override feature (4) is either downloaded from the NA (1a) or from the OS (2a) or both to the CCD (3). The emergency feature (4) allows the end user to select two options. Option one is the emergency services (4a) which connects the user to the local authorities such as fire or police or 911. Option two is the emergency contacts feature (4b) which allows the user to select and contact a predetermined emergency contact (4b) list such as parents, friends. This emergency override system connects to emergency services that are offered by the various network providers for smart phones, such as ATT on a standard basis.

FIG. 7B describes the 3^{rd} party override feature (5) but those well-known in the art will understand multiple alternatives are available. The 3^{rd} party override feature (5) is either downloaded from the NA (1a) or from the OS (2a) or both to the CCD (3). The 3^{rd} party override feature (5) allows a 3^{rd} party user to enter a custom four digit pass code (5a) and submit the pass code (5b) which unlocks the CCD OS (3) to its normal functionality. For instance, a parent shares a CCD (3) with their child and wants to use the phone without answering questions to unlock the CCD (3). The parent would select the 3^{rd} party override (5) enter the known four digit pass code (5a) and then submit the answer (5b).

Unlocking Application that Controls Access

FIG. 8 describes one possible configuration discussed in some embodiments where a device such as a smartphone has an unlock app which controls access to the device. The unlock app contacts cloud services which instruct it whether or not the device can currently only be unlocked via correct interaction with educational content, and then displays that content to a user. If the user properly interacts with the content (such as giving a correct answer to a question), the unlock app terminates its function and surrenders control of the device to the user.

According to some embodiments, a system may two main components, a native application (NA) (1), and cloud services (CS) (4) The native application (NA) runs on a cloud-connected client device (CCD) (3) and can be described as an unlock or login app that allows or restricts access to the rest of the device's functionality. Alternatively, the functionality delivered in the NA could be programmed directly into the CCD's operating system, (2) The NA is activated, (1a), whenever the device is powered up, restarted, or comes out of sleep mode. (If a device has just entered sleep mode, the NA may allow instant access without challenge, if the last time the device was accessed was within a certain period of time.) The NA immediately contacts CS web services (3A) via internet connection enabled by WiFi or Carrier Data Plan, using a URL which resolves thereto. The NA receives back from the CS a payload of information in a data packet in a common data interchange format such as XML or JSON, which contains educational content (EC) and an unlock status code (USC), which one familiar with the art would know is content within the cloud (CS). The USC may instruct the NA that the device is (a) unlockable, (b) freely unlockable, (c) unlockable after appropriate interaction with educational content, or (d) other conditional possibilities. If access to the device is conditional {i.e., (c) or (d)}, the NA will present a User Interface (UI) which will prompt the user to correctly interact with it in order to unlock the device. If the interaction is correct, the NA terminates after allowing full access to the device's operating system's main user interface for accessing the device's functionality. If the interaction is incorrect, the NA will process certain logical conditions which may allow second chances to interact correctly with educational content, optionally after a certain wait period, and/or allow visual and/or auditory access to learning content prior to answering again, and/or give second chances at new content, or completely block access, or other logical possibilities.

In some implementations, the content and/or conditions of unlocking and/or restrictions and/or conditions and/or rewards given for correct interaction, may be accessed from other third-party internet connected devices (5) via a secure app or web-portal, which enables authorized users to specify content, restrictions, rewards, and so on the CS (collectively “establishing the unlocking criteria”) (5a). In the case of the FIG. 8, the CS is accessed by separate and distinct cloud-connected instructor device (5).

In one example, a parent uses their third party device (5) to make a request thru the cloud server (4) for their child to answer to a series of drivers education questions thru (5a), in this case the child's electronic device is a “smart” system in a vehicle such as Ford's SYNCH, the cloud server then sends requested drivers education questions to the child's electronic device (3) thru (5b). Once the answer is processed from the “smart” system in the vehicle (3) the information is sent back to the cloud server (4) thru (3a). The cloud server (4) will then send the answer back to the third party device (5), in this case identified as the parent, thru (3b) which then tells the parent the answer. If correct, the cloud server (4) then allows access. In an alternative, example the parent could request that specific driving conditions such as speed and time at stop signs are monitored through the cloud server (4) which would process information in conjunction with a GPS system embedded in the child's device (or “smart” system of the vehicle). In some cases, the “smart” system of the vehicle would work in coordinate with the child's cell phone in part or whole.

The following definitions are an extension of the illustrations of FIG. 8, which one familiar with the art would recognize as industry terms that can be defined in multiple ways but the meaning stays the same.

Cloud-Connected Client Device (CCD) This is any consumer electronic device which has an operating system (OS) and internet access, inclusive of but not limited to: iPhone or other smartphone, iPod or other portable music player, iPad or other portable tablet device, laptop computer, desktop computer, netbook computer, XBox or other game console; Google TV or other television set-top box, or smart-TV with embedded computer hardware and OS; and so on.

Native Application (NA). This is an application that natively runs on the CCD's OS, either pre-installed to run at the login stage of the OS's boot sequence, or post facto installed on the CCD to either run on top of, concurrent with, or in lieu of, processes that the OS executes at the login stage of the CCD's boot sequence that is called upon power-up or restart/reboot or logout/login new user. For devices with sleep mode, such as always-on smartphones, the NA will also run at the preliminary stage the OS typically calls for logging into or unlocking of the device from sleep.

Cloud Services (CS)—To the CCD, the CS represent a family of web services that may be hosted on one isolated server, multiple isolated servers, or on distributed servers that virtually and agnostically appear to the CCD to be a single server. Individual CS web services are accessible by URL which contains both the address of the server to contact, the name of the particular web service to access, and the parameters of payload data to deliver to the web service, in the typical fashion of URL construction. The resource return by accessing the URL shall be a data packet (DP) in a proprietary data interchange format, or a common data interchange format such as XML or JSON. The primary and most important CS web service is the one where the NA first checks in with the CS, reporting such information as for example, GPS location, GPS location history, device usage history, and so on; and is returned the USC and optionally the EC (unlock status code and educational content). Other conditional logic may also be returned in this data packet, such as restrictive parameters for what time of day the device may be used, certain logical criteria for device usage (including but not limited to: 1—number of minutes that it may be used, 2—which applications may be used how often and/or when, 3—how much educational content must be interacted with correctly, 4—how much learning content (LC) must be viewed and for how long, 5—what conditional logic flow should be followed in case educational content is incorrectly responded to, and so on.). In some implementations, CS are isolated or divided onto isolated different servers to facilitate the isolation/organizing/management of diverse families of functions that may be accessed by some authorized parties but not others. For example, CS involving rewards may be on one server. CS involving submittal of new EC and dispersal of EC to CCD may be on separate servers. CS involving managing and controlling the locking/unlocking CCDs may be on separate servers. In order to properly function, these separate servers may need to privately share information with each other via messaging and API calls, via common interfacing and messaging techniques known to those skilled in the art.

Educational Content (EC)—An easily understood example of educational content, would be true/false or multiple choice questions. In many implementations, this is structured in a typical data format such as XML. In other implementations, this is structured in a proprietary data format. Besides the above, however, many other kinds of educational content are realizable. Since educational experiences are certainly not always in the form of viewing questions and giving answers, a very good example of an alternative form of educational content, would be content constructed with HTML-5+CSS+JavaScript—a web application. In this example, any possible way a web application can perform, present to, and interact with a user, becomes the educational content/educational experience that is presented to the user. In such implementations, whatever kind of interaction is deemed correct (be it amount of time, proper hand-eye coordination, proper navigation to a GPS location, proper answering of a question, proper composition of an essay, and so on) would be made known to the NA such that it can logically determine whether to unlock the device or do otherwise.

Unlock Status Code (USC)—This is a code within the DP (data packet) that instructs the device with current unlock instructions. For example, the USC could instruct the device that under no circumstance should it unlock (except to use emergency services). Or the USC could instruct the device that, because it is a holiday or weekend or vacation (or other condition), that it should immediately unlock without any requirement for educational content. Or the USC could instruct the device, that it must present the user educational content with which to interact, for a certain length of time, certain number of questions, certain percentage of correct responses or interactions, and so on.

Learning Content (LC)—Learning content (LC) is herein defined differently from EC, in that it is content which does not necessarily require interaction. It can be media such as video, audio, text, other media, or combinations of the foregoing. It may be presented to the CCD user prior to them interacting with EC, so that they have learned and are prepared to correctly interact. Or, it could be also presented after an incorrect interaction with EC, in order that the user may learn the correct interaction therewith.

### Alternative Implementations

In one implementation, all EC and/or LC is preloaded in the persistent data storage associated with the NA, such that it is not required to access CS to obtain such content.

In one implementation, all EC and/or LC is pre-cached in the persistent data storage, such that periodically, the NA pre-loads data that is ready on hand for instant on-device access when needed. This circumvents problems that may occur when device internet connectivity is absent or problematic, and increases speed and performance of unlocking. This pre-loading may occur in two ways: 1—Periodically the NA will check for updates to pre-loaded EC and/or LC data as a TSR (terminate and stay resident) process. 2—At each use of the NA for unlocking, the NA will check to see if it needs to update its pre-loaded data, which it will then fetch and have pre-loaded for future uses of the NA.

In one implementation, one, many, or all of the CS are not controlled by URL access to an external server hosting the CS, but rather, are controlled by the wireless carrier (WC) itself. Any attempt to access the WC's mobile data plan, SMS or MMS texting services, or telephony services, will be regulated by the carrier's servers and infrastructure, which will emulate the CS as already described in internal server APIs. The WC's internal server APIs will provide responses and information to its other services letting those services know whether they are currently locked and require unlocking via interaction with educational content, or have a different status as already described above in the different status conditions that the USC may indicate.

In another embodiment, the CCD for establishing the unlocking criteria could be the same CCD used for “establishing the unlocking criteria”.

FIG. 9 is a diagram illustrating example components of an adaptive learning process. In some instances each of the components is provided within a single electronic computer device (such as a smart phone), in other instances the components are provided in multiple devices including those that are connected directly or via a cloud type system. The first component is the Learning Agent 940, the second component is Reward Timing 950 and the third component is Reward Type 960.

In some implementations, the learning agent 940 may be comprised of five feature sets. Each feature set is intended to provide an example of the different types of learning agents or mechanisms that are relevant to a learner. The five feature sets that are provided are provided as examples for illustration purposes and are not a limitation of this invention.

The first feature set is “read” 902 and this comprises a traditional approach to learning in that a form text would provide a series of information that would provide learning. For instance, in the case of learning about the basic features of a cell being comprised of a membrane, a cytoplasm and nucleus, a student could simply read from a text book or an eBook. The second feature set is “hear” 904 and this comprises an approach to learning that is all based on hearing and sound. For instance, in the case of the basic features of a cell the student would listen to the relevant information via a headset of a recording or of a live remote lecture for example. The third feature set is “watch” 906 and this comprises an approach to learning that can include a combination of reading and hearing or each individually. For instance in the case of the basic features of the cell the student would watch a video, an animated story or a live lecture where information is written on a board or eBoard and the instructor is speaking along with the presented material. The fourth feature set is “interactive” 908 and this comprises an approach to learning that involves an interaction with the student. For instance in the case of the basic features of the cell the student would have an interactive puzzle or ePuzzle where by each of the major parts are presented and the learner must assemble the individual parts to demonstrate a mastery (or level of learning). The fifth feature set is a “combination” 910. The Learning Agent 940 can be “adapted” for each learner based on their particular learning style. In some cases an individual learner may have a preference for learning new information in the form of Reading 902 and then reinforcement learning (review of material verses new material) in the form of Interactive 908 (or vice versa). Further still, some individuals may require a combination that includes using different agents within a single topic based on levels of material, periods of time or combinations.

In some implementations, the reward timing 950 may be comprised of five feature sets. Each feature set is intended to provide an example of the different types of reward timing (time of granting a reward relative to time of accomplishing a task) that are relevant to a learner. The timing of the reward is relevant to a learning process because some learners need immediate gratification while others would prefer a randomly inspired reward. Further still, some learners require combinations. The five feature sets that are provided are provided as examples for illustration purposes and are not a limitation of this invention.

The first feature set is “now” 912 and this comprises a traditional approach to reward timing that would provide a reward at the completion of each correct answer (or completion of a targeted learning milestone such as reading a page of watching a vide). For instance, in the case of learning about the basics of multiplication the learner would be rewarded immediately after answering each individual question correctly such as 6×6=12. The second feature set is “periodically” 914 and this comprises an approach to reward timing that provides the learner with a reward at a fixed interval of time or frequency. For instance, in the case of the basics of multiplication the learner would be rewarded every nth time (such as every 10th correct question or every 10th minute of being engaged). The third feature set is “waiting” 916 and this comprises an approach to reward timing that provides the learner with a reward at the end of a session or end of multiple sessions. For instance, in the case of the basics of multiplication the learner would be rewarded at the end of a particular session (such as completing all exercise related 6's). The fourth feature set is “random” 918 and this comprises an approach to reward timing that provides the learner with a reward at a random point in a session. For instance, in the case of the basics of multiplication the learner would be rewarded at any time of a learning session including the first to third feature sets. Moreover, it would involve any time from starting point of engagement to termination point of a session. The fifth feature set is a “combination” 920 and this comprises an approach to reward timing that involves any and all combinations of the four sets. For instance, in the case of the basics of multiplication the learner could be rewarded at different levels of engagement whereas learning the 1's provides one type of reward and learning the 9's provides another type of rewards. For example, in some cases an individual learner may have a preference for learning new information in the form of “now” 912 reward and then reinforcement learning in the form of “random” 918 rewards. Further still, some individuals may require a combination that includes using different rewards within a single topic as the learner develops mastery skills.

In some embodiments, the reward type 960 is comprised of five feature sets. Each feature set is intended to provide an example of the different types of reward type that are relevant to a learner. The type of the reward is relevant because some learners need specific inspiration. The five feature sets that are provided are provided as examples for illustration purposes and are not a limitation of this invention.

The first feature set is an “app” 922 reward and this comprises an approach to a reward type such as access to an individual application on a smart device. For instance, in the case of learning about the basics of multiplication the learner would be rewarded, at the achievement point of a milestone, with access to an electronic device application such as Angry Birds®, calculator, including both those critical to the operation of the electronic device as well as those that are downloaded from app store such as Google Store. The second feature set is a “device” 924 reward and this comprises an approach to reward type such as access to all functionality of an electronic device (or multiple devices or combinations of applications within device). For instance, in the case of learning about the basics of multiplication in which an achievement point is realized the learner would be rewarded with access to all of the functionality of a game console such as a Xbox or a smart phone. The third feature set is a “money” 926 reward and this comprises an approach to reward type such as being granted access to (or being provided) money or a recognized currency. For instance, in the case of learning about the basics of multiplication in which an achievement point is realized the learner would be rewarded with access to money from a PayPal® account. The funding source can include a teacher, parent or corporate sponsor. The funding can take place electronically on the targeted device used for learning in one case. The funding source can include a teacher, parent or corporate sponsor. The fourth feature set is a “retail” 928 reward and this comprises an approach to reward type such as being granted access to a retail gift card, prize, etc. For instance, in the case of learning about the basics of multiplication in which an achievement point is realized the learner would be rewarded with a gift card from Target. The funding source can include a teacher, parent or corporate sponsor. The fifth feature set is a “combination” 930 and this comprises an approach to reward timing that involves any and all combinations of the four sets. For instance, in the case of the basics of multiplication the learner could be rewarded at different levels of engagement whereas learning the 1's provides one type of reward and learning the 9's provides another type of rewards. For example, in some cases an individual learner may have a preference for learning new information in the form of “app” 922 reward and then reinforcement learning in the form of “retail” 928 rewards. Further still, some individuals may require a combination that includes using different rewards within a single topic as the learner develops mastery skills.

In some implementations, an adaptive (or responsive form) of tabulating all of this information may be constructed for each individual as a custom profile using the gridlines in FIG. 9. Thus, a learner can be profiled against each of the three components, learning agent 940, reward timing 950, and reward type 960. With this profile a responsive system could analyze past performance and anticipate current and future performance thereby providing the targeted learner with custom learning agent, customer reward timing and reward type.

With respect to a classroom or teaching environment with multiple learners this adaptive approach may be particularly effective for an eClassroom where each student is using an electronic device. In this particular instance, the electronic device can be the vehicle that provides the rewards and administers the decisions. Alternatively, the analyses and reward types can be hosted from a cloud-based system. A teacher could administer entirely custom experiences for each of her students by relying on the feedback collected through integrated system.

In one example, a teacher is teaching a classroom of children biology. The lesson is a simple overview of the cell which is composed of membrane, cytoplasm and nucleus. The teacher presents the class objective—learning about the cell. The children are then directed to a series of learning material such as paragraph explanation, an illustration, a video, and an interactive exercise. Furthermore, the children are given reward options which range from social media time to game time. Each are subjected to a test and the test is provided in either written, visual or audio.

Using this adaptive and highly customized approach, incorporating algorithms common to one familiar with the art, to determine what learning material is most appropriate (and the targeted level of language) for the individual, combined with the history of rewards (based on level of difficulty and attention span) the learning experience is optimized. This can include the venue of the test (i.e. written/oral etc.) In other words, if an objective is to get the child to understand the individual differences of membrane, cytoplasm, and nucleus then the method by which they children learn the targeted learning and prove they have mastered it is secondary.

In yet another example, each of the components learning agent, reward timing and reward type can be further interconnected to bio-physical elements (discussed in detail in earlier) so that important patterns of the students learning anxiety and excitement may be included in the process. For example, the system could determine through bio-physical elements a student is experiencing anxiety despite the custom experience. In this case, the system could introduce a surprise reward or reduction in learning material difficulty at a sequence until the bio-physical signs stabilize.

### Sound Level Control

A voice decibel mechanism that will shut down the software system (or otherwise modify the reward portion or the earning portion if the electronic device detects a sound emitted from the user (or from the smart device itself) at a level higher (as measured in decibels) than a pre-set (or personalized) limit. One familiar with voice decibel systems and the widely available applications to record and detect the decibel level from the electronic device would understand the manner in which the hardware of the electronic device already contains the detection and measurement equipment. In particular, the U.S. patent application Ser. No. 13/568,950 describes many of the features capable of being monitored by the electronic device. This feature disclosed in various embodiments may be particularly useful in a classroom setting where one student might be enjoying a privilege he earned by playing a game while another student is still earning time. In other words, in a classroom setting, when the student is enjoying their reward, he may elect to play a game such as Angry Bird. If the student had the volume too high or was laughing too loud the sound level control would intercept the session. However, any other environmental settings where the sound level is concerned are relevant as well.

Optionally, in one example, the sound level control could simply remove some or all of the time that was earned during session with this invention if a sound level exceeded the established threshold. Further, the sound level control could send out a warning, in the form a dropdown message (like a banner add) before taking an action of shutting down or removing time. In the case of the volume of the device exceeding the established limits the device could adjust itself to the appropriate level or simply eliminate its sound emitting capability for a specific time, or event such as use of a particular application or function. Alternatively, the sound level detected by the electronic device could be used to measure the excitement of the end user engaged in the learning objective. For example, a person excited about completing a module could exert sounds of exhilaration. Conversely, someone frustrated with the learning experience could exert grunts of frustration. One familiar with the art of language and human sound could understand the nature of the differences of the sounds and their implications on learning.

In yet another example, a toy's operation could be influenced by sound level detection. For instance, a boy operating his interactive robot could have his robot cease operation (or provide a warning) when the boys voice exceeds a certain threshold. Similarly, a girl engaging with her interactive doll could have her doll cease operation (or provide a warning) when the girl's voice exceeds a certain threshold.

### Special Needs Population

It is also noted that the features discussed in various embodiments of this invention are suitable for use in a variety of situations beyond parent/child and teacher/student, such as by employers training employees, clinicians engaging in rehabilitation of patients who are mentally impaired, etc. For example a child with autism could be provided with educational content on basic hygiene routines, while an adult with Alzheimer's could be provided with education content on family history. The features of this invention may also involve self-monitored learning by an individual who has elected to master a new subject (e.g. foreign language) or exercise their intellect (e.g. memory and analytical exercises for an aging individual). In this scenario, the individual would function as both the system “user” and “third party” by selecting the scope of access denied to the device, such as the entire device or the Internet, or the Facebook® website, etc.; and being provided the analyzed results of their progress directly from the system server.

In another example the electronic device could be used for monitoring the movement via a range of electronic devices such as a smart phone, smart watch or smart glasses. A movement in a targeted motion or position that is part of a learning or training program would be rewarded by providing expanded or full functionality of targeted electronic device(s).

Notwithstanding the examples and references with an emphasis on educational learning, the system and method disclosed in various embodiments of the invention are of particular relevance to other learning applications and conditions or third-party controlled instructions or requests such as, but not limited to, those in medical rehabilitation, hospital patients, special needs children, employee, professional groups (such as accountants, doctors, and lawyers who require annual continued professional credits), specialized training courses, athletic training, physical education, military training, trivia, pre-natal care, emergency response, farming basics, sanitation and infectious disease prevention, domestic violence awareness, and so forth.

As a particular example using a patient reducing brain deterioration with customized mental exercises: A medical-dementia patient elects to use the network as a gateway where for example she informs AT&T Inc. to enable only enable her critical communications including television satellite until after she achieves specific targets on brain exercises. She selects the education venue so that she could identify the precise elements of her brain between cognitive and pattern recognition that were further diminished. These areas then become the priority in her daily exercises. For her reward, she selects retail such as a meal at Denny's restaurant (including senior citizen discount for mental game progress)

### Facial Recognition

In yet another instance of analytical mechanisms, facial recognition software such as programs created to track the “face print” can be incorporated into the analytical process by which a learner is engaged in a series of questions or instructions. For example, a “face print” is a series of various relative positions of various data points on a given face (e.g. nose, eyes, lips, eye brows, etc.) these different data points can be used to determine not only the face print (or the person to whom the face belongs) but the individual data points can also reveal the mood of the face (happy, sad, angry). When compared to the time to answer a question or the level of difficulty (including type of question) the tracking of the facial expression of mood would provide valuate analytical information to those familiar with the art of teaching and learning including adaptive learning. In one of many examples known to those in the level of difficulty to a question could be changed before the student even answered the question. In other words, instead of waiting for the student to submit an incorrect answer before changing the level of difficulty an adaptive program could change the reduce the level of difficulty as the expressions become more frustrated (frown) or increase the level of difficulty as the expressions become more excited (smile or laugh gesture).

In yet another example, a toy's operation could be influenced by facial gestures. For instance, a boy operating his interactive robot could have his robot change operation (or provide a warning) when the boys face indicates frustration. Similarly, a girl engaging with her interactive doll could have her doll cease operation (or provide a warning) when the girl's face indicates sadness.

### Optical Scan Analysis

Examples of common eye movement patterns include the following: Visual Construction, looking up and to the left. The person is accessing information from their imagination and might possibly be making it up; Visual Remembering—looking up and to the right. This is when the person is actually accessing a memory and picturing it in his head. Auditory Construction—looking middle and to the left. This is where a person's eyes might go if he was constructing a sound in his mind; Auditory Remembering—looking middle and to the right. This is where a person's eyes might go if he was remembering a sound that he had heard previously; Kinesthetic—looking down and to the left. This is the direction a person's eyes might go if he was accessing his actual feelings about something; and Auditory Digital—looking down and to the right. This is the direction a person's eyes might go when he is talking to himself. All of these provide a new insight that would be a powerful analytical tool to helping and end user better learn or perform the instructions.

Further still, the pupils can be observed and changes in the pupils size (dilation) can provide a new dimension into a student's learning process or an individuals behavior modification. More specifically, the size of the pupils (dilation) can indicate whether the end user is experiencing a higher (larger pupil size) or lower (smaller lower pupil size) challenge based on an optical tracker. This evidence can contribute to the learning material being introduced to the end user so it can be adjusted upward or downward (in difficulty) based on the desired learning platform.

As background, pupil dilation generally correlates with arousal so consistently that researchers use pupil size, or pupillometry, to investigate a wide range of psychological phenomena. Stimulation of the autonomic nervous system's sympathetic branch, known for triggering “fight or flight” responses when the body is under stress, induces pupil dilation. Whereas stimulation of the parasympathetic system, known for “rest and digest” functions, causes constriction. Inhibition of the latter system can therefore also cause dilation.

In one study, a scientist observed that when he instructed subjects to remember and recite a series of seven digits, their pupils grew steadily as the numbers were presented one by one and shrunk steadily as they unloaded the digits from memory. Subsequent research found that the pupils of more intelligent people (as defined by their Scholastic Aptitude Test scores) dilated less in response to cognitive tasks compared with those of lower-scoring participants, indicating more efficient use of brainpower.

In an example, a toy's operation could be influenced by level of eye engagement. For instance, a boy operating his interactive robot could have his robot change operation such as power down or become more engaging (or provide a warning) when the boys eyes reveal he is uninterested or is getting very excited. Similarly, a girl engaging with her interactive doll could have her doll power down or become more engaging (or provide a warning) when the girl's eyes reveal she is uninterested or is getting very excited.

### Wearable Smart Devices

Wearable smart devices, in simple terms, are attempts to free data (and other calculating aspects like movement, environmental measurements, calorie consumption, calories burned bio-monitoring, etc.) from desktop computers and portable devices. More specific examples include devices that tracks steps (and stairs) as well as sleep with a vibrating alarm, including an “optimal” wake-up window, that analyzes motion so one can be waken up during the lighter portions of his sleep cycle rather than jarring him awake in the middle of deep sleep.

Many are designed to have Bluetooth®, WiFi and GPS built in. This enables the devices to be used as standalone smart device or in combination with another smart device such as a phone, tablet, etc.

There are different companies that have already emerged with different versions of wearable smart devices and they include Fitbit® offerings, Google Glass®, Samsung Galaxy Gear®, GreenPeak® offerings, InvenSense® offerings, Lumus® offerings, Motorola Solutions® offerings, Nike FuelBand®, Vuzix® offerings and Withings® offerings.

Notable examples of commercial items that one familiar with the art would realize could be interchangeable with the traditional smart devices used such as phone, tablet, game counsel, smart tv, automobile include the products from Fitbit Inc. and Google Inc.

Fitbit Inc. offers several different products that include: Flex™ wireless sleep and activity tracker bracelet that tracks movement, calories consumed, sleeping, etc., Zip™ wireless activity tracker a clip on device that tracks steps, distance, calories burned, stairs climbed and sleep, Aria™ wifi weight scale (a standard home use scale configuration) that tracks weight, body mass index. Each of these devices and all of the information are sent via number of electronic methods where the information is tracked and summarized on the cloud or personal electronic device. Fitbit Inc. also offers an open API so many of the data captures can be shared and included with developments and applications.

Essentially, a Google Glass® is a camera, display, touchpad, battery and microphone built into spectacle frames so that you can perch a display in your field of vision, film, take pictures, search and translate on the go to name a few features. Bluetooth® and Wi-Fi will be built in. A user may user her Google Glass® to interact with the gateway system discussed in various embodiments. The Google Glass and other smart devices may be locked down until targeted learning is completed. They can also provide signals that can be used to support the decision of whether a learning objective was met.

Further, the signals can be used to help contribute to important vital signs of the student or end user and that information can be used to compliment the analytic information that contributes to the “adaptive” learning. Further still, signals from devices like scales can be incorporated into the invention to help an end user learn how to better manage and understand their weight condition. For example, the instruction for an end user could be to weigh himself each morning and record the previous days physical activity and calorie consumption. Until this instruction is followed the target electronic device (or devices), with exception of scale in this case, are locked until the instruction is completed.

### “Smart” Systems for Automobiles

“Smart” car systems such as those offered by Ford Sync® include a range features that can be synchronized. To power Sync, Ford Motor Company partnered with Microsoft Corporation for the software. Microsoft Corporation created Microsoft Auto software, which can interface with just about any current MP3 player or Bluetooth® cell phone. Passengers can connect their cell phones through Sync's integrated Bluetooth technology. The software will seek the address book and transfer the names and numbers to an internal database. Like many existing Bluetooth cell phone links, Sync is capable of voice-activated, hands-free calling. Push a button on the steering wheel, and you can speak the name or number you wish to call.

Sync diverts from the traditional Bluetooth® path by utilizing text-to-speech technology to read aloud any text messages you might receive while driving. The system can translate commonly used text message phrases such as “LOL” (laughing out loud). In turn, you can reply to an audible text message from one of 20 predefined responses. Sync® also supports many of the other features found on cell phones, including caller ID, call waiting, conference calling, a caller log, and signal strength and battery charge icons. When you receive a call, Sync can play personal ring tones, including special tones for specific callers. All this information is shown on the radio display screen.

As Sync® primarily runs on software, the system is upgradeable. Ford Motor Company and Microsoft Corporation have plans to allow dealer service technicians to perform updates when the vehicles are in for scheduled maintenance. Updates may also be available on a Web-site for consumers to download and install.

Since the introduction of Sync in the 2008 model year, other car makers have launched similar systems. General Motors Company has expanded its OnStar® service and integrated Sync-like features into its infotainment system, and has even added smartphone apps so drivers can do things like unlock and start their cars remotely. Hyundai Motor Company is launching its Bluelink® service on some 2012 models. Bluelink not only has things like vehicle tracing and crash notifications services, but also includes features like Bluetooth® integration, and location services that allow your car to check in at various locations—something that's helpful if you're a social media fanatic.

### Lottery Style Rewards

The gateway system can include a progressive lottery type of syndicate whereby it is a linked system. In this system a group of students join into a particular type of learning or sign up for a particular type of reward that is provided by a corporate or retail sponsor. For example a group of students studying similar content for a test prep such as the SAT could all compete for a random reward. Specifically, the commonalty is the SAT content and they are each competing for a randomly generated reward. Conversely, a group of employees within a large organization with multiple locations around the world could sign up for a specific reward (such as additional vacation time, a gift certificate for coffee, etc.) regardless of their job training content. Specifically, the commonalty is not the learning content—it is the specific reward.

In another case, the students could wager their accumulated time against each other whereby a single winner (or group of winners) take all or the majority of the collective time. This could be done on an individual, class or school level including any combination of participants. The competition amongst the students could include games one familiar with motivational behavior would know and include those games based on a skill or knowledge, a physical action (like running), a physical change (like gaining or losing weight), luck (like those associated with compulsion) or game of chance or any combination.

### Global Positioning Satellite (GPS) Systems

In the case of tracing GPS coordinates, many smart devices come with a built-in GPS function. The GPS function is a byproduct of using a smart device. For example, the built-in receiver trilaterates your position using data from at least three GPS satellites and the receiver. GPS can determine ones location by performing a calculation based on the intersection point of overlapping spheres determined by the satellites and your phone's GPS receiver. In simple terms, trilateration uses the distance between the satellites and the receiver to create overlapping “spheres” that intersect in a circle. The intersection is your location on the ground. This GPS feature has been incorporated into a number of native applications and web based applications that incorporate the smart devices user's location. Examples include Groupon®, Facebook® Nearby, and Eventseeker. In each of the examples, the smart device user can be informed when he enters a specific set of coordinates about a particular discount at restaurant, a friend's proximity or a an entertainment event. The “GPS coordinates” demonstrates what one familiar with the art could do to enable the smart device to become a tracking beacon for periods of time that include until a target event occurs or the passage of a prescribed amount of time.

Using GPS signals, the students are identified while in a Retail store and join the contest through their electronic devices. In one embodiment each of the students is in the same location in another embodiment the students are in different locations. In another example, students can represent groups of students in classrooms or any group, such as a church group. In lieu of the GPS coordinates, the activity of the contest could include any type of membership program that could allow students or groups, to enroll and compete in the contest from remote locations, through the cloud.

The assessment and gateway functions may further comprise utilizing location based content and calculating the location of the user via, for example, the use of global positioning system (GPS) capabilities on the user's electronic computing device. The user may be required to perform a physical task (e.g. running around neighborhood, walking home from school at certain time and route) that is tracked by the user's device. Likewise, the content of the questions is location based. For example, a student walks into a math class 5 minutes before class starts and he would like to text. The gateway would be math themed questions of the day sponsored by the teacher of math questions customized to the student's current trends on tests and quizzes. And in a commercial setting, a customer at Starbucks® store or website might be asked a series of questions about the nutritional value of his most recent purchases. Further still, in an employment setting the employee may be asked a series of questions about laboratory safety or emergency exits as they move from one plant to another.

### GPS-Based Trigger for Locking and Unlocking Mechanism

The reward may be initiated by the global positioning service (GPS) of the electronic device and the relative location of the student using the electronic device. For example, in one case the student could be walking home from school and passing by a Starbucks. At such time, as he falls with a specific boundary of the GPS coordinates relative to the Starbucks a reward potential could be activated to induce the student to learn in exchange for an immediate reward upon completing a particular learning assignment. As a simple example, the student could complete a module on his SAT prep at the Starbucks and receive an immediate reward.

In another case, a random reward could be location based where for example if a student was walking by a retail sponsor they could be informed of a particular reward. In the location based award a set of GPS coordinates would be activated such that any electronic device traveling within such GPS coordinates triggers a reward such as drop into WalMart® store for a discount or a free soda.

### GPS-Based Check-Ins for Locking and Unlocking Mechanism

In another example of the invention, a third-party might require the device user on certain days of the week to (1) show up and check in to a specific location such as a school location by a certain time, (2) check in as still at school at the same location end of the school day, (3) check in at home by a certain time, (4) check in at home later in the evening to prove the user is still there. Rewards rules can be specified such as all four rules must be met for five days in a row to trigger a full allowance, or that for each check-in, $2 is accumulated into the allowance credits, or indeed, any number of other rules for rewards as described elsewhere. Each “check in session” could include specific unique learning questions or instructions that are customized to the end user to further confirm that the end user and the end user's device are in the specified coordinates requested by the third party.

### Electronic Device Usage/Credit Provided by Network Provider or Sponsor

In one scenario the student is provided a credit or full payment for their monthly service bill from their cell phone and/or cable carrier. The services that would be included would include all communications such as radio communications and satellite communications along with 2G to 4G Wi-Fi, cable and combinations as well. In a further example, the student is provided an electronic device and each day he earns time to access the features on the device in exchange for achieving targeted learning objectives. In a specific example, an at-risk child could be provided an electronic device and each incremental period such as a 24 hour period, a specific amount of learning content such as that related to the GED (general education diploma) would require a level of mastery in exchange for using the device for the incremental period. Further still, the results could be reported to third-party such as a sponsor or teacher or both.

### Anti-Cheating Mechanism

An electronic device could be programmed with a motion detection sensor such that the user has to keep both hands on the phone. In one case he would have his left hand under the phone and his right hand held against the home screen while he calculates the answer in his head. In other words, an intent of the anti-cheating is to prevent the user from going to another device, such as a calculator or a friends smart device to solicit the answer. If an unauthorized motion is detected then a new instruction or question could be generated. In another instance of anti-cheating mechanisms an optical tracking software such as the programs created by Tobii Technology, Inc. or the eye tracking software from Samsung Group in their Android 4.2 version. Using optical tracking if the user takes his eye off or away from the screen for a preset time such as 3 seconds then another instruction or question would be created for example.

In each case of an expected act of cheating, the result could be an immediate suspension of use, limited accessibility, reduced time, time subtracted, etc. These are only a few examples of how one familiar with the art of teaching and electronic device detection features would include in an anti-cheating mechanism.

### Compulsion Loop

Researchers and scientists are frequently publishing reports that refer to the new levels of addiction to electronic entertainment. For example, one study of more than 1,000 students from 10 countries and 12 universities concluded that the majority were not able to voluntarily forego their electronic connections for a mere 24 hours. In particular, the study found that these college students admitted to being “addicted” to modern technology such as mobile phones, laptops and television as well as social networking applications offered by Facebook, Inc. and Twitter, Inc.

Functional magnetic resonance imaging (fMRI) was used, in another study, to visualize which parts of the brain were engaged during certain aspects of social media. The overall conclusions were that the use of social media, and in particular expressing one's owns opinion, positively triggers dopamine reward pathways. The researchers even determined that many of the subjects would prefer reporting their own experiences to receiving a monetary reward.

Similar indications were noted in certain video gaming, which introduce high levels of “randomness” in reward granting as an intentional means of forming an addiction. The idea dates back decades and its used to create a compulsion loop that keeps the player engaging in the activity. The technique is referred to as the variable ratio of reinforcement (or operant conditioning). It is considered simple and powerful and is believed to be one of the reasons gambling is so addictive. This trend of operant conditioning has also led to a number of allegations that emailing possesses addictive characteristics. In fact, a new term of “emailoholics” emerged as the result of one author's studies. In this regard, using a random nature of rewards would entice the end users or students to engage in the invention. Further, having a system that enables a range of different reward types and levels is a targeted objective of this invention as well.

### Captive Marketing and Advertising

While the user is locked out of his phone (or electronic device) or participating in a contest while trying access to his phone, advertisers including the retailers have a captive audience for a host of different advertising options to those familiar with the art of on-line advertising and marketing on the world wide web. In one instance, the advertiser could use a retailers name in the form of the various questions, such as if one mocha from a Retailer costs $2.00 and a customer purchases five mochas, how much will the customer spend is an example of a question. Alternatively, if the Retailer's rewards card has $50.00 credit and a customer spends $17.50 what is the balance on the rewards card is another example of a question. Alternatively, banner adds could be placed or other features such as the mathematics content is brought to you a particular Retailer.

A critical feature of the locking mechanisms is the creation of a unique opportunity for targeted marketing that is used directly or indirectly with education, instruction or contest material. In such a case, advertisers would compensate the hosting cloud (or network) who is coordinating the introduction of the marketing material into the education content directly (or any parties working indirectly together or in combinations) as part of the question or as a separate advertisement. In yet another embodiment of the invention the separate advertisement may be accessible directly or only after another question or series of questions is generated on the display of the electronic device. Further still, the advertisers could rely on the nature of the content of the questions for the demographics of the targeted end user providing both a captive audience in combination with a demographically focused end user or group of end users. This example of a system and method of captive marketing and advertising is not limited to only these examples rather it is illustrative of one aspect of the current invention. The captive marketing mechanism could be integrated into each of the examples and illustrations included herein by one familiar with the relevant art.

In such a case, advertisers would compensate a hosting software who is coordinating the introduction of the marketing material into the education content directly as part of the question or as a separate advertisement. In yet another embodiment of the invention the separate advertisement may be accessible directly or only after another question or series of questions is generated. Further still, the advertisers could rely on the nature of the content of the questions for the demographic of the targeted user providing both a captive audience along with a demographically focused. This discussion of captive marketing in not limited to these examples rather its is illustrative of one aspect of the current invention.

The reward feature may be further exemplified and enhanced by the type of reward trigger, the reward types, the rewards redemption, reward gamesmanship, and reward providers. Below are specific examples of each and demonstrate the various types of individual activities that one familiar with the art could incorporate.

Rewards Triggers include: check-in at certain places such as school, third-party school reporting, extracurricular conditions/goals, completion of chores, school attendance, homework completion, direct teacher third party reporting, API to teacher server for tracking grades, API to school hosting server, accomplishing specified blocks of educational content, exposure to certain blocks/time periods of learning content (video, audio, ebook), incentives for study groups/studying content together with device users, group contests, educational content, extracurriculars—outside contests that specify device user(s) as meeting, criteria, and allot those rewards to qualifying user id's for redemption

Rewards Types include: Cumulative allowance credit, activated in portions for continued performance of criteria rules, Periodic allowance credit activated periodically for fulfilling minimum conditions, Third Party bestowal and third party can immediately bestow through portal for arbitrary things (mowing lawn, polite behavior, etc.)

Rewards Redemption include: partnership with Square, Inc. and/or other mobile payment apps/companies, partnership with credit card company—puts money right on a debit card credits stored as data which work toward participating partner programs, partnerships with vendors/sponsors, and programs/contests at school or other third parties

Rewards Gamesmanship include: students can double down (or specified extra reward) with rewards by completing extra credit education content, students can risk losing x and stand to gain y, by attempting harder extra credit, question(s) which proved an A+ level of excellence in learning the material, a special Third Party at any “real life” gamesmanship can be designated to be, the “decider” of an award or contest, for example, for a sprint, or a talent, show, and immediately bestow the award to the user via their user id to a portal or directly using his device and the user's device through application on each device using NFC or QR code or what not.

Rewards Providers include: Vendors, Schools/institutions and Third Party (parent)—selects a goal such as bicycle, wherein transaction using THEIR credit card gets unlocked by meeting rewards triggers/criteria. One familiar with the art would understand how these can be incorporated into the various reward features illustrated elsewhere in this document.

### Toys and Other Devices

The features discussed in various embodiments may also be used in conjunction with existing interactive toys and robots. For standalone toys and robots, and other electronic computing devices that are not connected to a network, the educational software is installed on the device, toy, or robot and coded to be compatible with the specific device and any other computer software associated with it. As a result, the user would have to successfully execute the testing modules of the present invention in order to gain access to the device, toy, or robot. And for interactive toys, robots, and other electronic computing devices connected to a network, the Educational software is downloaded to the device, toy, or robot, or accessible via the Question & Answer (Q & A) system server; and is coded to be compatible with the specific device, toy, or robot and any other software associated with it (e.g. toy mobile app). In other instances the interactive toys can be turned off by failing to complete the targeted objectives or the interactive toys level of interaction can be based on the advancement of the learning modules within the framework of this invention.

The features discussed in various embodiments can be integrated into these “smart” features in the car and will thusly disable the features in the car directly through the target electronic devices or into the separate software of the vehicle using API or other means well known to those in the art.

Combinations of electronic devices and smart device maybe incorporated into an embodiment of this invention whereby a variety of individual devices are used to achieve the learning objective. For example, smart glasses, a smart watch used in combination with a smart phone and a game console could be used to optimize the features of the sound section, anti-cheating and optical scanning features, among other items.

### CONCLUSION

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

What is claimed is:

1. A non-transitory computer-readable storage medium storing computer instructions which when executed cause a computer to perform a method of blocking and/or limiting access to a computer device until a user answers one or more questions correctly, the method comprising:
a. displaying one or more questions on a graphical user interface of the computer device;
b. receiving a response from the user to the question(s);
c. determining if the response from the user is a correct answer;
d. when the user's response is the correct answer, unblocking access to the computer device;
e. when the user's response is not the correct answer, requesting the user to respond to the same question again or a new question;
f. blocking and/or limiting access to the computer device for a predetermined period of time when after repeating steps (a) thru (e) one or more times, the user has not provided a correct response;
g. transmitting a result of determining if the response is the correct answer to a third party to supervise the user's progress,
h. wherein the computer device is an electronic device comprising a smartphone, a tablet, a laptop computer, a desktop computer, an interactive toy, or a robot, and
i. wherein the user is required to view a video on the computer device comprising content related to the questions before step (a) and/or after step (e).

2. The non-transitory computer-readable storage medium of claim 1, wherein the method further comprises
selecting a content, format, and quantity of the one or more questions in accordance of an instruction from the user, wherein:
a. the content specifies a subject matter of the one or more questions,
b. the format specifies a structure of the one or more questions selected from a group of true/false, multiple choice, short answer, and fill-in-the-blank structures; and,
c. the quantity specifies an amount of time of using the computer device earned by the user for answering the question(s) correctly.

3. The non-transitory computer-readable storage medium of claim 2,
wherein the amount of time of using the computer device corresponds to an unlimited amount of access, a specific duration of access, or an amount of credit for using the computer device, and
wherein each unit of credit earns the user a specific duration of access and the credit may be saved for future use.

4. The non-transitory computer-readable storage medium of claim 3,
wherein the units of credit earned are based on the user correctly answering a series of consecutive questions of increasing complexity, and
wherein the amount of earned credit is determined by the number of correct responses within the series.

5. The non-transitory computer-readable storage medium of claim 3, wherein the units of credit earned are based on a level of complexity of a question the user answers correctly.

6. The non-transitory computer-readable storage medium of claim 1, further comprising
unblocking the computer device in response to an input from the user of a pre-designated code to transmit an electronic message to emergency contacts,
wherein the electronic message comprises a VoIP phone call, cellular phone call, SMS text message, instant message, or email.

7. A network-based computer system for blocking or limiting access to a client computer until a user answers one or more questions correctly, the system comprising:
a. a system server, comprising:
i. a database storing results of analyzing responses from the user to educational questions and records of a third party receiving the results;
ii. an education module managing educational questions categorized by content, format, and quantity, wherein
the content specifies a subject matter of the questions;
the format specifies a structure of the questions selected from a group of true/false, multiple choice, short answer, and fill-in-the-blank structures; and,
the quantity specifies an amount of time of using the client computer earned by the user for answering the questions correctly;
b. a processor for determining a correctness of the responses;
c. one of more user client computers each comprising a graphical user interface for communicating with the system server to enable a user to select the content, format, and quantity of one or more questions, to input responses to test questions, and to review test results; and
d. one or more third party client computers each comprising a graphical user interface for receiving reports from the system server on the user's responses to the test questions,
e. wherein each client computer is an electronic device comprising a smartphone, a tablet, a laptop computer, a desktop computer, an interactive toy, or a robot.

8. The network-based computer system of claim 7, furthering comprising
an emergency override module enabling the user to unblock a client computer by inputting a pre-designated code to transmit an electronic message to emergency contacts,
wherein the electronic message comprises a VoIP phone call, cellular phone call, SMS text message, instant message, or email.

9. The network-based computer system of claim 7, wherein the processor further analyzes the responses to quantify an amount of progress made by the user in learning tested content, to identify learning trends, strengths, and weaknesses of the user, and to provide a report comprising a summary of the analysis to the third party via electronic communication.

10. The network-based computer system of claim 9, wherein the processor analyzes the responses by calculating an average amount of time for a user to respond to questions of a specific content.

11. The network-based computer system of claim 9, wherein the processor identifies learning trends by comparing test results provided by the user for the optimal time of day, the optimal testing environment, and the optimal question format to achieve a highest number of correct answer to questions.

12. The network-based computer system of claim 9, wherein the processor identifies learning strengths and weaknesses by determining types of content and types of format that the user consistently answers correctly and incorrectly.

13. The network-based computer system of claim 7, wherein the educational module further manages standardized test questions derived from third party sources.

14. The network-based computer system of claim 13, wherein the standardized test questions comprise SAT, ACT, MCAT, LSAT, GMAT, and/or GRE practice test questions.

15. A computer implemented method for blocking access to a computer device until a user answers one or more questions correctly, the method comprising:
displaying one or more questions on a graphical user interface of the computer device;
b. receiving a response from the user to the question(s);
c. determining if the response from the user is a correct answer;
d. when the user's response is the correct answer, unblocking access to the computer device;
e. when the user's response is not the correct answer, requesting the user to respond to the same question again or a new question;
f. blocking and/or limiting access to the computer device for a predetermined period of time when after repeating steps (a) thru (e) one or more times, the user has not provided a correct response;
g. transmitting a result of determining if the response is the correct answer to a third party to supervise the user's progress,
h. wherein the computer device is an electronic device comprising a smartphone, a tablet, a laptop computer, a desktop computer, an interactive toy, or a robot, and
i. wherein the user is required to view a video on the computer device comprising content related to the questions before step (a) and/or after step (e).

16. The computer implemented method of claim 15, further comprising selecting content, format, and quantity of the one or more questions, wherein:
a. the content specifies a subject matter of the one or more questions,
b. the format specifies a structure of the one or more questions selected from a group of true/false, multiple choice, short answer, and fill-in-the-blank structures; and,
c. the quantity specifies an amount of time of using the computer device earned by the user for answering the question(s) correctly.

17. The computer implemented method of claim 16,
wherein the amount of time of using the computer device corresponds to an unlimited amount of access, a specific duration of access, or an amount of credit for using the computer device, and
wherein each unit of credit earns the user a specific duration of access and the credit may be saved for future use.

18. The computer implemented method of claim 17,
wherein the units of credit earned are based on the user correctly answering a series of consecutive questions of increasing complexity, and
wherein the amount of earned credit is determined by the number of correct responses within the series.

19. The computer implemented method of claim 17, wherein the units of credit earned is based on a level of complexity of a question the user answers correctly.

20. The computer implemented method of claim 15, further comprising
unblocking the computer device in response to an input from the user of a pre-designated code to transmit an electronic message to emergency contacts,
wherein the electronic message comprises a VoIP phone call, cellular phone call, SMS text message, instant message, or email.

21. A method of reward-based advertisement on an electronic device using a hierarchy of rewards, comprising:
associating a reward at each level of the hierarchy with an advertisement;
transmitting the advertisement associated with the reward at a current level to the electronic device only after delivering the reward at a previous level to the electronic device; and
delivering the reward at a current level to the electronic device only after the advertisement associated with the reward at the current level is viewed on the electronic device,
wherein the reward at the first level is an authorization for access of a native function of the electronic device.

22. An electronic device for reward-based advertisement, comprising:
a first receiving unit configured to receive a request from a user for a reward at a level of a hierarchy of rewards,
wherein a reward at each level of the hierarchy is associated with an advertisement, and
wherein the reward at the first level is an authorization for access of a native function of the electronic device;
a second receiving unit configured to receive an acknowledgment from a user that an advertisement displayed by the electronic device is viewed; and
a display unit configured to
display the advertisement associated with the reward at a level in response to a request for the reward, and
display information regarding a reward at a level in response to receiving an acknowledgement from a user that the advertisement associated with the reward is viewed,
wherein the display unit displays the advertisement associated with the reward at a current level only after displaying information regarding the reward at a previous level.
